(19) United States
(12) Patent Application Publication
(10) Pub. No.: US 2020/0200100 A1
(43) Pub. Date: Jun. 25, 2020

(54) Throttle Valve Controller Device for Internal Combustion Engine

(71) Applicant: Hitachi Automotive Systems, Ltd., Hitachinaka-shi, Ibaraki (JP)

(72) Inventors: Haoyun SHI, Tokyo (JP); Takafumi ARAKAWA, Tokyo (JP); Yoichi IIHOSHI, Tokyo (JP); Kunihiko SUZUKI, Tokyo (JP); Toshio HORI, Hitachinaka-shi (JP); Yoshikuni KURASHIMA, Hitachinaka-shi (JP)

(21) Appl. No.: 16/612,804

(22) PCT Filed: May 11, 2018
(86) PCT No.: PCT/JP2018/018262

§ 371 Date: Nov. 12, 2019

(30) Foreign Application Priority Data
Jun. 1, 2017 (JP) 2017-109061

(51) Int. Cl. F02D 9/02; F02D 41/00; F02D 21/08

(52) U.S. Cl. CPC F02D 9/02; F02D 2009/0201; F02D 21/08; F02D 41/0072

(57) ABSTRACT

There is provided a novel throttle valve controller device for an internal combustion engine that is capable of accurately producing a target torque for the internal combustion engine. The present invention includes a target fresh intake air flow rate calculating section that calculates a target fresh intake air flow rate passing through a throttle valve, an EGR gas flow rate calculating section that calculates an estimated EGR gas flow rate passing through the throttle valve, a target throttle intake gas flow rate calculating section that calculates a target intake gas flow rate passing through the throttle valve on the basis of the target fresh intake air flow rate and the estimated EGR gas flow rate, and a target throttle valve opening calculating section that calculates a target throttle valve opening from the target intake gas flow rate. Since the target throttle opening is set based on the target fresh intake air flow rate and the through-throttle EGR gas flow rate passing through the throttle valve, a target torque can be produced accurately.

### TECHNICAL FIELD

The present invention relates to a control device for an internal combustion engine that controls the combustion of an air-fuel mixture in a combustion chamber, and more particularly to a throttle valve controller device for an internal combustion engine incorporating therein an EGR system for recirculating an exhaust gas into an intake system.

### BACKGROUND ART

Recent internal combustion engines are arranged to recirculate part of an exhaust gas into an intake system for reducing a pump loss and a cooling loss and also reducing noxious components of the exhaust gas. One system for recirculating part of an exhaust gas into an intake system, hereinafter referred to as “EGR system,” is disclosed in JP-2012-255371-A (Patent Document 1), for example.

Patent Document 1 reveals an internal combustion engine including an EGR passage that provides fluid communication between an exhaust passage and an intake passage of the internal combustion engine, an EGR valve for controlling the flow passage area of the EGR passage, and a throttle valve disposed in the intake passage for controlling the flow passage area of the intake passage. An exhaust gas controlled by the EGR valve, hereinafter referred to as “EGR gas,” is mixed with air in the intake passage and then supplied as an intake gas to a combustion chamber. In the description that follows, a gas before it is mixed with the EGR gas will be referred to as “fresh intake air” and a gas after it is mixed with the EGR gas will be referred to as “intake gas.”

According to Patent Document 1, a target intake pressure, i.e., a pressure downstream of the throttle valve, is calculated based on a target flow rate for an intake gas that represents the sum of a target flow rate for an EGR gas to be taken into the combustion chamber that has been calculated in view of a flow response delay of the EGR gas and a target flow rate for fresh intake air also to be taken into the combustion chamber. Patent Document 1 further describes calculating a target throttle opening required to realize the calculated target intake pressure. Thus, Patent Document 1 describes calculating the target throttle opening by determining the target intake pressure from the target flow rate for the intake gas.

### PRIOR ART DOCUMENT

### Patent Document

Patent Document 1: JP-2012-255371-A

### SUMMARY OF THE INVENTION

### Problems to be Solved by the Invention

The internal combustion engine disclosed in Patent Document 1 includes the EGR system in which the EGR gas is recirculated downstream of the throttle valve, i.e., a downstream-of-throttle-valve EGR system. Therefore, the EGR system is not applicable to an EGR system in which the EGR gas is recirculated upstream of the throttle valve, i.e., an upstream-of-throttle-valve EGR system. In other words, according to Patent Document 1, on the premise of the downstream-of-throttle-valve EGR system, a target throttle opening is calculated by determining a target intake pressure from the target flow rate for the intake gas including the target flow rate for the EGR gas that flows into the combustion chamber in bypassing relation to the throttle valve.

In contrast, according to the upstream-of-throttle-valve EGR system, as the EGR gas passes through the throttle valve, it is necessary to determine an opening, i.e., an opening area, of the throttle valve in view of the flow rate of the EGR gas that passes through the throttle valve. Consequently, the process disclosed in Patent Document 1 fails to set an accurate opening for the throttle valve and is unable to produce a target torque accurately.

It is an object of the present invention to provide a novel throttle valve controller device for an internal combustion engine that is capable of accurately producing a target torque for the internal combustion engine.

### Means for Solving the Problems

According to the present invention, there is provided an upstream-of-throttle-valve EGR system having an EGR passage connected to an upstream of a throttle valve and including a target fresh intake air flow rate calculating section that calculates a target fresh intake air flow rate passing through the throttle valve, a through-throttle EGR gas flow rate calculating section that calculates a through-throttle EGR gas flow rate passing through the throttle valve, a target throttle intake gas flow rate calculating section that calculates a target throttle intake gas flow rate passing through the throttle valve on a basis of the target fresh intake air flow rate and the through-throttle EGR gas flow rate, and a target throttle valve opening calculating section that calculates a target throttle valve opening for the throttle valve from the target throttle intake gas flow rate.

### Advantages of the Invention

According to the present invention, since the target throttle opening is set based on the target fresh intake air flow rate and the estimated EGR gas flow rate passing through the throttle valve, a target torque can be produced accurately.

### BRIEF DESCRIPTION OF THE DRAWINGS

FIG. 1 is a configurational view of an internal combustion engine incorporating a low-pressure EGR system to which the present invention is applicable.

FIG. 2 is a block diagram of a control block of a throttle valve controller device according to a first embodiment of the present invention.

FIG. 3 is a diagram explanatory of the behaviors of a target torque, a target throttle valve opening, and an intake gas flow rate.

FIG. 4 is a flowchart of a control sequence of the throttle valve controller device according to the first embodiment of the present invention.

FIG. 5 is a flowchart of a control sequence of a throttle valve controller device according to a second embodiment of the present invention.

FIG. 6 is a diagram explanatory of the behaviors of a target torque, a target throttle valve opening, and an intake gas flow rate according to the second embodiment.

FIG. 7 is a block diagram of a control block of a throttle valve controller device according to a third embodiment of the present invention.

FIG. 8 is a flowchart of a control sequence of the throttle valve controller device according to the third embodiment of the present invention.

### MODES FOR CARRYING OUT THE INVENTION

Embodiments of the present invention will hereinafter be described in detail below with reference to the drawings. However, the present invention is not limited to the embodiments to be described below, but covers in its scope various modifications and applications within the technical concept of the invention.

### First Embodiment

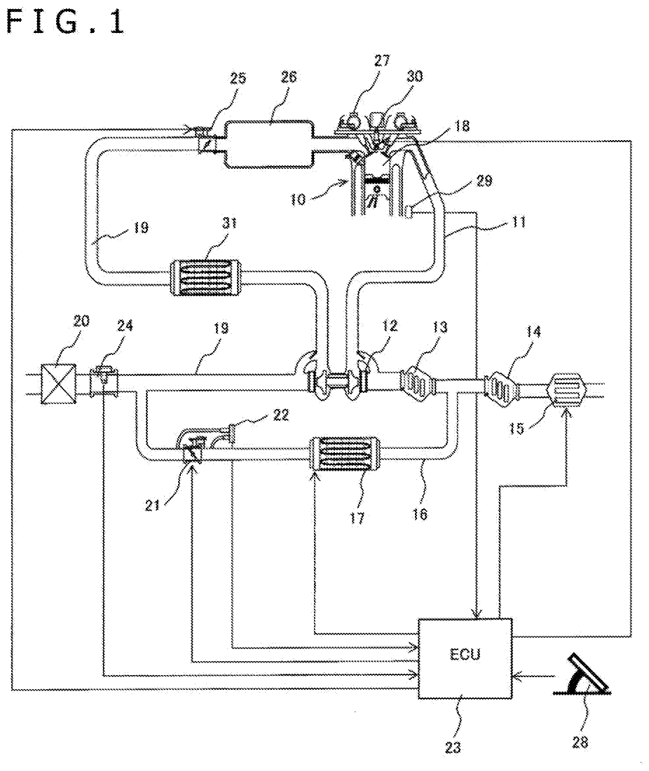

FIG. 1 illustrates the configuration of an internal combustion engine incorporating an upstream-of-throttle-valve EGR system to which the present invention is applicable. The internal combustion engine, denoted by 10, includes an exhaust passage 11 defined by a pipe in which a turbocharger 12 and a pre-catalytic converter 13 are disposed. The turbocharger 12 includes a turbine that rotates in response to the flow of an exhaust gas, a shaft that transmits the rotation of the turbine, and a compressor that takes in and compresses air based on the running torque of the turbine. The turbocharger 12 has a supercharging function to actuate the compressor based on the flow of the exhaust gas to increase the density of the air in an intake gas that is drawn into the internal combustion engine 10.

The exhaust gas from the internal combustion engine 10 is purified by way of reduction and oxidation by the pre-catalytic converter 13 and a main catalytic converter 14. A particulate substance that cannot be purified by the pre-catalytic converter 13 and the main catalytic converter 14 is purified by a particle removal filter, i.e., a GRF (Gasoline Particulate Filter), 15.

Part of the exhaust gas purified by the pre-catalytic converter 13 is taken into an EGR pipe 16 from downstream of the pre-catalytic converter 13, cooled by a gas cooler 17, and returned upstream of the turbocharger 12. Upstream of the turbocharger 12 refers to a region where an intake gas flows into the turbocharger 12. Part of a combustion gas produced in a combustion cylinder 18 of the internal combustion engine 10 flows through the EGR pipe 16 back into an intake passage 19 where it is mixed with fresh intake air that is newly drawn in from outside through an air cleaner 20. An intercooler 31 is disposed in the intake passage 19 downstream of the turbocharger 12.

The air cleaner 20 removes dust contained in the fresh intake air that is drawn in. The flow rate of an EGR gas flowing back from the EGR pipe 16 is determined by controlling the opening of an EGR valve 21. By controlling the EGR gas, it is possible to lower the combustion temperature of an air-fuel mixture in the combustion cylinder 18 to reduce the discharged amount of NOx and also to reduce a pump loss, and the like. A differential pressure sensor 22 that is installed across the EGR valve 21 detects the difference between a pressure forward of the EGR valve 21 and a pressure rearward of the EGR valve 21, i.e., a differential pressure.

The internal combustion engine 10 is controlled by a controller device 23. An air flow rate sensor 24 detects the flow rate of fresh intake air that is newly drawn in from outside. Although not shown, a pressure sensor is installed somewhere between the turbocharger 12 and the combustion cylinder 18. The pressure sensor detects the pressure in the intake passage 19 that leads to the combustion cylinder 18 or in an intake collector 26 disposed downstream of a throttle valve 25.

The flow rate of the intake gas that flows from the intake passage 19 into the combustion cylinder 18 is controlled by the opening of the throttle valve 25 or a variable-phase valve timing mechanism 27 that varies the opening and closing timing of an intake valve or an exhaust valve.

The controller device 23 according to the present embodiment controls an actuator, i.e., an electric motor, of the throttle valve 25 in order to realize a target intake gas flow rate based on at least a required target torque, hereinafter referred to as “target torque,” required by the driver, which is detected by an accelerator pedal sensor 28, and a rotational speed detected by a rotational speed sensor 29. The controller device 23 also controls actuators, i.e., electric motors, of the EGR valve 21 and the throttle valve 25 in order to realize a target EGR ratio based on the detected value from the pressure sensor, referred to above, the opening of the throttle valve 25, or the detected value from the air flow rate sensor 24.

According to the present embodiment, the EGR ratio refers to the ratio of the flow rate of the EGR gas to the flow rate of fresh intake air in the intake gas flowing through the intake passage 19. The controller device 23 detects the difference between the pressure forward of the EGR valve 21 and the pressure rearward of the EGR valve 21, i.e., the differential pressure, with the differential pressure sensor 22, and sets openings of the EGR valve 21 and the throttle valve 25 based on the detected pressure difference, or sets phase angles of the intake and exhaust valves with the variable-phase valve timing mechanism 27, thereby controlling the EGR ratio of the intake gas flowing into the combustion cylinder 18. Furthermore, the controller device 23 controls the ignition timing of an ignition plug 30 to optimize that in order to prevent knocking and maximize the output power of the internal combustion engine 10.

The internal combustion engine that incorporates the upstream-of-throttle-valve EGR system illustrated above is already well known in the art, and will not be further described below. Next, a control block of a throttle valve controller device according to a first embodiment will be described below.

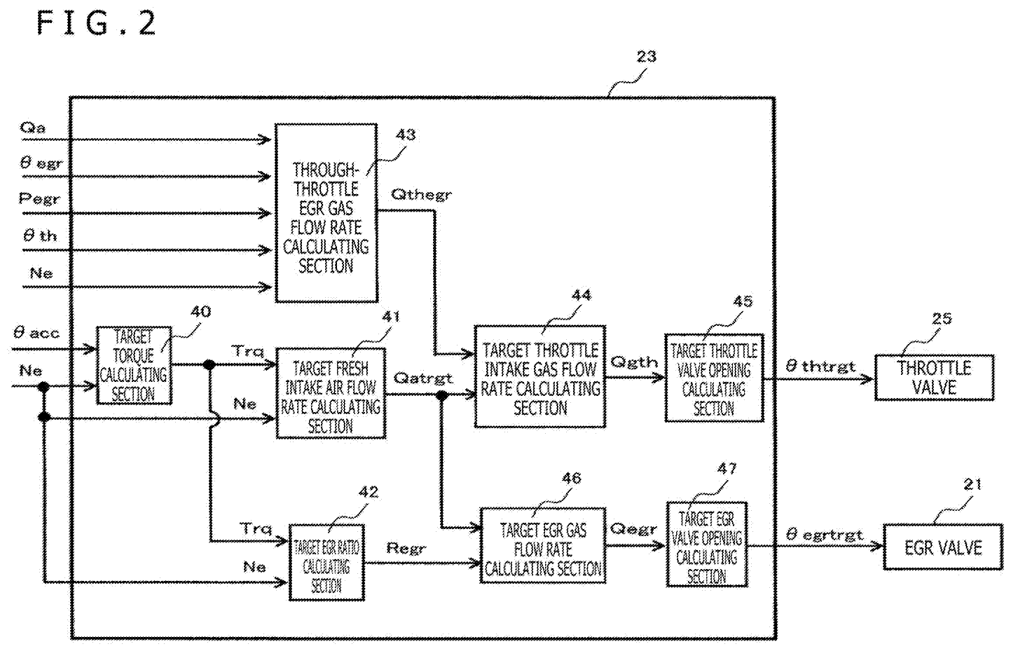

FIG. 2 illustrates a control block of the controller device 23. The controller device 23 includes a target torque calculating section 40, a target fresh intake air flow rate calculating section 41, a target EGR ratio calculating section 42, a through-throttle EGR gas flow rate calculating section 43, a target throttle intake gas flow rate calculating section 44, a target throttle valve opening calculating section 45, a target EGR gas flow rate calculating section 46, and a target EGR valve opening calculating section 47. Next, specific functions of these calculating sections will be described below.

The target torque calculating section 40 calculates a target torque Trq that the internal combustion engine 10 is to output, based on a depressed quantity θacc, detected by the accelerator pedal sensor 23, representing a target torque required by the driver, and a rotational speed Ne detected by the rotational speed sensor 29. The target torque Trq may be determined according to a formula or may be determined from a map based on the rotational speed Ne and the depressed quantity θacc. According to the present embodiment, a map retrieval process is employed for higher calculation speeds. The determined target torque Trq is sent to the target fresh intake air flow rate calculating section 41.

The target fresh intake air flow rate calculating section 41 calculates a target fresh intake air flow rate Qatrgt for realizing the target torque Trq determined by the target torque calculating section 40, based on the rotational speed Ne detected by the rotational speed sensor 29 and the target torque Trq. In this case, too, the target fresh intake air flow rate Qatrgt may be determined according to a formula or may be determined from a map based on the rotational speed Ne and the target torque Trq. According to the present embodiment, a map retrieval process is employed for higher calculation speeds. The determined target fresh intake air flow rate Qatrgt is sent to the target throttle intake gas flow rate calculating section 44 and the target EGR gas flow rate calculating section 46 to be described later.

The target EGR ratio calculating section 42 calculates a target EGR ratio Regr based on the rotational speed Ne detected by the rotational speed sensor 29 and the target torque. The target EGR ratio Regr may be determined according to a formula or may be determined from a map based on the rotational speed Ne and the target torque Trq. According to the present embodiment, a map retrieval process is employed for higher calculation speeds. The determined target EGR ratio Regr is sent to the target EGR gas flow rate calculating section 46 to be described later.

The through-throttle EGR gas flow rate calculating section 43 calculates a flow rate of the EGR gas as the EGR gas flows from the EGR valve 21 until the EGR gas passes through the throttle valve 25, based on an air flow rate Qa detected by the air flow rate sensor 24, an opening θegr of the EGR valve 21, a differential pressure Pegr detected by the differential pressure sensor 22 that is installed across the EGR valve 21, an opening θth of the throttle valve 25, and the rotational speed Ne detected by the rotational speed sensor 29, and the like, in view of the operation delay time, i.e., the dead dime, of the EGR valve 21 and the flow delay times, i.e., dead times, due to the passage lengths of the EGR passage 16 and the intake passage 19, and estimates a through-throttle EGR gas flow rate Qthegr that is to pass finally through the throttle valve 25. The through-throttle EGR gas flow rate Qthegr may be estimated, for example, as follows:

First, there are established two divided calculation areas upstream and downstream of the throttle valve 25. A through-EGR-valve EGR gas flow rate is calculated from the differential pressure detected by the differential pressure sensor 22 that is installed across the EGR valve 21 and the opening of the EGR valve 21. Then, a fresh intake air flow rate is detected by the air flow rate sensor 24. Further, the through-EGR-valve EGR gas flow rate and the fresh intake air flow rate are added up, and a through-compressor gas flow rate in the turbocharger 12 and an EGR ratio are calculated.

Then, using the through-compressor gas flow rate and the throttle intake gas flow rate through the throttle valve 25 that has been calculated in the preceding calculation cycle, a pressure, a temperature, and a mass in the area upstream of the throttle valve 25 are calculated, and a throttle intake gas flow rate through the throttle valve 25 in a present calculation cycle is calculated based on the pressure, the temperature, and the mass that have been calculated. Finally, using the throttle intake gas flow rate through the throttle valve 25 in the present calculation cycle and the EGR ratio calculated in the preceding calculation cycle, a through-throttle EGR gas flow rate Qthegr that is to pass through the throttle valve 25 is calculated.

The through-throttle EGR gas flow rate Qthegr to be estimated may be determined by constructing the above physical model. The physical model is arbitrary and may be of any configuration insofar as it is able to estimate a through-throttle EGR gas flow rate Qthegr through the throttle valve 25. The determined through-throttle EGR gas flow rate Qthegr is sent to the target throttle intake gas flow rate calculating section 44.

The target throttle intake gas flow rate calculating section 44 calculates a target throttle intake gas flow rate Qgth passing through the throttle valve 25 according to the following equation (1) from the target fresh intake air flow rate Qatrgt determined by the target fresh intake air flow rate calculating section 41 and the through-throttle EGR gas flow rate Qthegr determined by the through-throttle EGR gas flow rate calculating section 43:

[Equation 1]

Qgth=Qatrgt+Qthegr (1)

The determined target throttle intake gas flow rate Qgth is sent to the target throttle valve opening calculating section 45.

The target throttle valve opening calculating section 45 calculates a target throttle valve opening θthtrgt from the target throttle intake gas flow rate Qgth calculated by the target throttle intake gas flow rate calculating section 44, and controls the electric motor that actuates the throttle valve 25. In this case, too, the target throttle valve opening θthtrgt may be determined according to a formula or may be determined from a map based on the target throttle intake gas flow rate Qgth. According to the present embodiment, a map retrieval process is employed for higher calculation speeds. Moreover, the target throttle valve opening θthtrgt may be calculated by correcting a target throttle valve opening, based on the temperature and pressure upstream of the throttle valve 25 and the pressure downstream of the throttle valve 25. Such an alternative will be described later with respect to a third embodiment.

The target EGR gas flow rate calculating section 46 calculates a target EGR gas flow rate Qegr according to the following equation (2) from the target fresh intake air flow rate Qatrgt determined by the target fresh intake air flow rate calculating section 41 and the target EGR ratio Regr determined by the target EGR ratio calculating section 42:

[Equation 2]

Qegr=Qatrgt×Regr/(1−Regr) (2)

The determined target EGR gas flow rate Qegr is sent to the target EGR valve opening calculating section 47.

The target EGR valve opening calculating section 47 calculates a target EGR valve opening θegrtrgt from the target EGR gas flow rate Qegr calculated by the target EGR gas flow rate calculating section 46, and controls the electric motor that actuates the EGR valve 21. In this case, too, the target EGR valve opening θegrtrgt may be determined according to a formula or may be determined from a map based on the target EGR gas flow rate Qegr. According to the present embodiment, a map retrieval process is employed for higher calculation speeds.

Since the EGR gas passes through the throttle valve 25 in the upstream-of-throttle-valve EGR system, the above arrangement can determine an opening area of the throttle valve 25 in view of the EGR gas flow rate passing through the throttle valve 25. It is thus possible to set an accurate opening area of the throttle valve 25 for producing a target torque accurately.

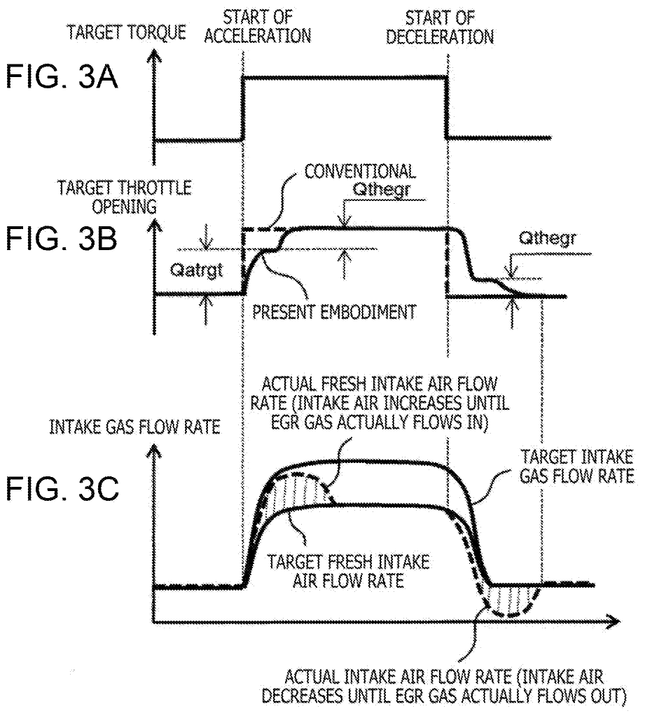

Next, operation and advantages of the present embodiment will be described below. FIG. 3 illustrates the behaviors of changes in a target torque, a target throttle valve opening, and an intake gas flow rate. Broken-line curves indicate a conventional example and solid-line curves indicate an example of the present embodiment.

As illustrates in (A) of FIG. 3, when the driver depresses the accelerator pedal 28 for acceleration, a target torque increases accordingly. In order to achieve the target torque, heretofore, the opening of the throttle valve 25 also increases in proportion as indicated by the broken-line curve in (B) of FIG. 3. There is a certain delay time, i.e., a dead time or a flow delay time, for the EGR gas from being supplied to the intake passage 19 after passing through the EGR valve 21 until reaching the throttle valve 25.

If a target EGR ratio is now regarded as being achieved and the throttle valve 25 is quickly opened as indicated by the broken-line curve in a manner to match the target flow rate of an intake gas that is a mixture of fresh intake air and the EGR gas, then the fresh intake air that corresponds to the EGR gas that has not reached the throttle valve 25 flows through the throttle valve 25 into the combustion cylinder 18. Therefore, as illustrated in (C) of FIG. 3, an actual fresh intake air flow rate becomes excessively large compared with a target fresh intake air flow rate including the increase in the flow rate of the EGR gas, resulting in a phenomenon where an actually produced torque, i.e., an actual torque, is larger than the target torque.

On the other hand, as illustrates in (A) of FIG. 3, when the driver releases the accelerator pedal 28 for deceleration, a target torque decreases accordingly. In order to achieve the target torque, heretofore, the opening of the throttle valve 25 also decreases in proportion as indicated by the broken-line curve in (B) of FIG. 3.

In this case, on account of the delay time of the EGR gas, the EGR gas is still supplied through the EGR valve 21 to the intake passage 19, and flows continuously through the throttle valve 25. If the EGR gas is regarded as flowing out and the throttle valve 25 is quickly closed as indicated by the broken-line curve, then the EGR gas still flows through the throttle valve 25 into the combustion cylinder 18 because of the above delay time. Therefore, as illustrated in (C) of FIG. 3, an actual fresh intake air flow rate becomes excessively small compared with a target fresh intake air flow rate including the decrease in the flow rate of the EGR gas, resulting in a phenomenon where a produced torque is smaller than the target torque.

If the target fresh intake air flow rate becomes excessively large or small, as described above, then the accuracy with which to control the produced torque is lowered, tending in some cases to impair the driving performance due to knocking or misfiring.

On the other hand, according to the present embodiment, since the target fresh intake air flow rate Qatrgt calculated by the target fresh intake air flow rate calculating section 41 and the through-throttle EGR gas flow rate Qthegr calculated by the through-throttle EGR gas flow rate calculating section 43 are added to each other by the target throttle intake gas flow rate calculating section 44, the delay time of the EGR gas can be compensated for.

Specifically, the through-throttle EGR gas flow rate calculating section 43 calculates the flow rate of the EGR gas as the EGR gas flows from the EGR valve 21 until the EGR gas passes through the throttle valve 25, from the physical model supplied with inputs representing the air flow rate Qa, the EGR valve opening θegr, the differential pressure Pegr across the EGR valve, the throttle valve opening θth, the rotational speed Ne, and the like in view of the operation delay time, i.e., the dead dime, of the EGR valve 21 and the flow delay times due to the passage lengths of the EGR passage 16 and the intake passage 19, and estimates the through-throttle EGR gas flow rate Qthegr that is to pass finally through the throttle valve 25.

As illustrated in (B) of FIG. 3, inasmuch as the through-throttle EGR gas flow rate Qthegr is estimated as “0” or small based on the delay time of the EGR gas during an initial stage of acceleration in which the target torque increases, the target throttle intake gas flow rate Qgth that is the sum of the through-throttle EGR gas flow rate Qthegr and the target fresh intake air flow rate Qatrgt is represented by only the target fresh intake air flow rate Qatrgt or a target throttle intake gas flow rate Qgth smaller than heretofore, so that the opening of the throttle valve 25 decreases accordingly. As a consequence, the target fresh intake air flow rate Qatrgt during the initial stage of acceleration is reduced, and so is the produced torque.

Furthermore, as illustrated in (B) of FIG. 3, inasmuch as the through-throttle EGR gas flow rate Qthegr is estimated as large based on the delay time of the EGR gas during an initial stage of deceleration in which the target torque decreases, the target throttle intake gas flow rate Qgth that is the sum of the through-throttle EGR gas flow rate Qthegr and the target fresh intake air flow rate Qatrgt is larger than heretofore, so that the opening of the throttle valve 25 increases accordingly. As a consequence, the target fresh intake air flow rate Qatrgt is increased, and so is the produced torque.

According to the present embodiment, as the through-throttle EGR gas flow rate Qthegr passing through the throttle valve 25 reflects the delay time of the EGR gas, the opening of the throttle valve 25 is controlled accordingly. Therefore, the phenomenon which the fresh intake air flow rate upon acceleration is excessively large and the phenomenon which the fresh intake air flow rate upon deceleration is excessively small are suppressed, resulting in an increase in the accuracy with which to control the produced torque.

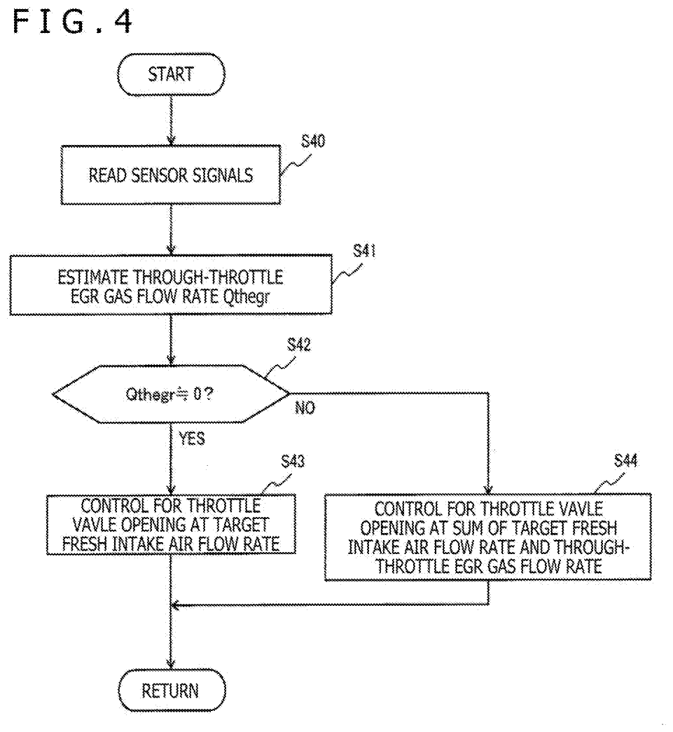

Next, a control sequence of the throttle valve controller device according to the first embodiment described above will briefly be described below with reference to FIG. 4. The control sequence represents a control process upon switching of the EGR valve from a closed state to an open state, and is repeatedly executed at each certain activation timing.

<<Step S40>> In step S40, the various sensors read the air flow rate Qa, the EGR valve opening θegr, the differential pressure Pegr across the EGR valve, the throttle valve opening θth, the rotational speed Ne, and the like required by the physical model that estimates a through-throttle EGR gas flow rate. When the inputs required by the physical model have been read, control goes to step S41.

<<Step S41>> In step S41, the flow rate of the EGR gas as the EGR gas flows from the EGR valve 21 until the EGR gas passes through the throttle valve 25 is calculated from the physical model based on the read inputs in view of the operation delay time, i.e., the dead dime, of the EGR valve 21 and the flow delay times due to the passage lengths of the EGR passage 16 and the intake passage 19, and the through-throttle EGR gas flow rate Qthegr that is to pass finally through the throttle valve 25 is estimated. When the through-throttle EGR gas flow rate Qthegr has been determined, control goes to step S42.

<<Step S42>> In step S42, it is determined whether or not the estimated through-throttle EGR gas flow rate Qthegr passing through the throttle valve 25 is equal to or smaller than a predetermined minimum flow rate (≈0). If the estimated through-throttle EGR gas flow rate Qthegr is equal or smaller than the predetermined minimum flow rate, then control goes to step S43. If the estimated through-throttle EGR gas flow rate Qthegr exceeds the predetermined minimum flow rate, then control goes to step S44.

<<Step S43>> In step S43, if the estimated through-throttle EGR gas flow rate Qthegr determined in step S41 is equal or smaller than the predetermined minimum flow rate, it is judged that the EGR gas has not reached the throttle valve 25, and the throttle valve 25 is controlled for a throttle valve opening corresponding to the target fresh intake air flow rate Qatrgt. Thereafter, control goes to return, waiting for a next activation timing.

<<Step S44>> In step S44, if the estimated through-throttle EGR gas flow rate Qthegr determined in step S41 exceeds the predetermined minimum flow rate, it is judged that the EGR gas has reached the throttle valve 25, and the target fresh intake air flow rate Qatrgt and the through-throttle EGR gas flow rate Qthegr are added to each other, and the throttle valve 25 is controlled for a throttle valve opening corresponding to the target throttle intake gas flow rate Qgth that is the sum of the target fresh intake air flow rate Qatrgt and the through-throttle EGR gas flow rate Qthegr. Thereafter, control goes to return, waiting for a next activation timing.

According to the present embodiment, as the through-throttle EGR gas flow rate through the throttle valve reflects the delay time of the EGR gas, the opening of the throttle valve is controlled accordingly. Therefore, the phenomenon which the fresh intake air flow rate upon acceleration is excessively large and the phenomenon which the fresh intake air flow rate upon deceleration is excessively small are suppressed, resulting in an increase in the accuracy with which to control the produced torque.

Moreover, according to the present embodiment, since a target EGR ratio is realized by adjusting the target fresh intake air flow rate in view of the delay time of the EGR gas, the amount of fuel to be injected and the ignition timing can accurately be controlled for reducing noxious components of the exhaust gas.

### Second Embodiment

Next, a second embodiment of the present invention will be described below. The present embodiment is different from the first embodiment in that the through-throttle EGR gas flow rate and the target EGR gas flow rate are compared with each other to correct the opening of the throttle valve.

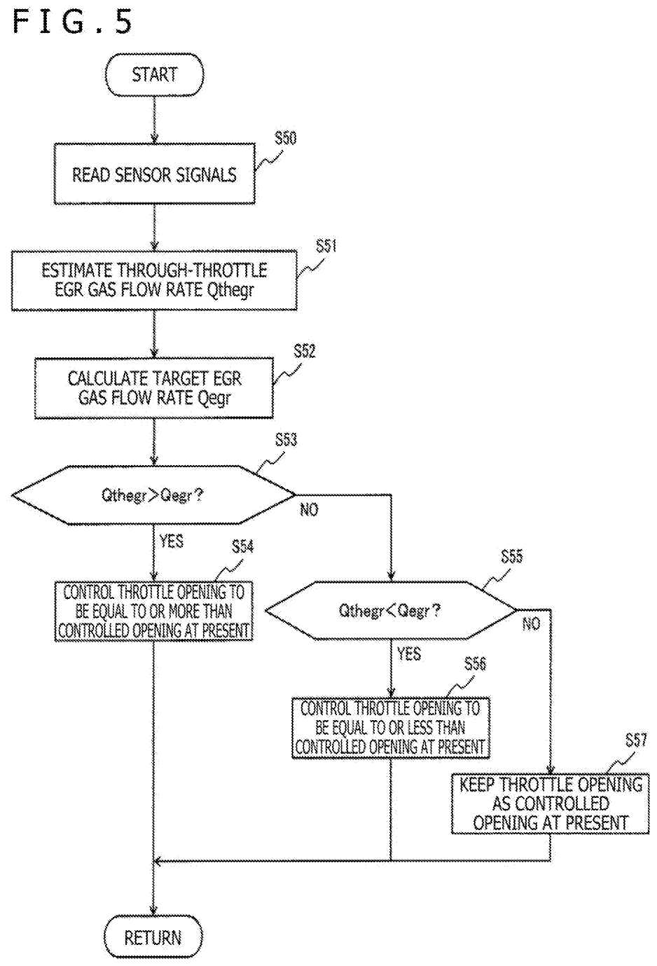

A control sequence of a throttle valve controller device according to the second embodiment described above will briefly be described below with reference to FIG. 5.

<<Step S50>> In step S50, the various sensors read the air flow rate Qa, the EGR valve opening θegr, the differential pressure Pegr across the EGR valve, the throttle valve opening θth, the rotational speed Ne, and the like required by the physical model that estimates a through-throttle EGR gas flow rate. When the inputs required by the physical model have been read, control goes to step S51.

<<Step S51>> In step S51, the flow rate of the EGR gas as the EGR gas flows from the EGR valve 21 until the EGR gas passes through the throttle valve 25 is calculated from the physical model based on the read inputs in view of the operation delay time, i.e., the dead dime, of the EGR valve 21 and the flow delay times due to the passage lengths of the EGR passage 16 and the intake passage 19, and the through-throttle EGR gas flow rate Qthegr that is to pass finally through the throttle valve 25 is estimated. When the through-throttle EGR gas flow rate Qthegr has been determined, control goes to step S52.

<<Step S52>> In step S52, a target EGR gas flow rate Qegr is calculated according to the above equation (2) based on the target fresh intake air flow rate Qatrgt and the target EGR ratio Regr. When the target EGR gas flow rate Qegr has been determined, control goes to step S53.

<<Step S53>> In step S53, it is determined whether or not the through-throttle EGR gas flow rate Qthegr calculated in step S51 is larger than the target EGR gas flow rate Qegr calculated in step S52. If it is judged that the through-throttle EGR gas flow rate Qthegr is larger than the target EGR gas flow rate Qegr, then control goes to step S54.

On the other hand, if it is judged that the through-throttle EGR gas flow rate Qthegr is smaller than or equivalent to the target EGR gas flow rate Qegr, then control goes to step S55.

<<Step S54>> In step S54, if the through-throttle EGR gas flow rate Qthegr exceeds the target EGR gas flow rate Qegr, then the throttle valve opening is set to a value equal to or larger than the “controlled opening” at present. The “controlled opening” at present refers to a throttle valve opening corresponding to the target throttle intake gas flow rate Qgth determined by adding the target fresh intake air flow rate Qatrgt and the through-throttle EGR gas flow rate Qthegr determined in the first embodiment.

Moreover, an opening for increasing the controlled opening may be set depending on the difference between the through-throttle EGR gas flow rate Qthegr and the target EGR gas flow rate Qegr. In other words, the larger the difference is, the larger the opening for increasing the controlled opening becomes. This can further increase the accuracy with which to control the produced torque. Furthermore, it is also possible to put a limiter on the opening for increasing the controlled opening for restraining the opening of the throttle valve from increasing excessively.

When the opening of the throttle valve has been corrected, control goes to return, waiting for a next activation timing.

<<Step S55>> In step S55, it is determined whether or not the through-throttle EGR gas flow rate Qthegr calculated in step S51 is smaller than the target EGR gas flow rate Qegr calculated in step S52. If it is judged that the through-throttle EGR gas flow rate Qthegr is smaller than the target EGR gas flow rate Qegr, then control goes to step S56.

On the other hand, if it is judged that the through-throttle EGR gas flow rate Qthegr is larger than the target EGR gas flow rate Qegr, then since it means that the through-throttle EGR gas flow rate Qthegr is equivalent to the target EGR gas flow rate Qegr, control goes to step S57.

<<Step S56>> In step S56, if the through-throttle EGR gas flow rate Qthegr is smaller than the target EGR gas flow rate Qegr, then the throttle valve opening is set to a value equal to or smaller than the “controlled opening” at present. The “controlled opening” at present refers to a throttle valve opening corresponding to the target throttle intake gas flow rate Qgth as described in step S54.

Moreover, as with step S54, an opening for increasing the controlled opening may be set depending on the difference between the through-throttle EGR gas flow rate Qthegr and the target EGR gas flow rate Qegr. In other words, the larger the difference is, the larger the opening for reducing the controlled opening becomes. This can further increase the accuracy with which to control the produced torque. Furthermore, it is also possible to put a limiter on the opening for reducing the controlled opening for restraining the opening of the throttle valve from decreasing excessively.

When the opening of the throttle valve has been corrected, control goes to return, waiting for a next activation timing.

<<Step S57>> In step S57, since the through-throttle EGR gas flow rate Qthegr and the target EGR gas flow rate Qegr are equivalent to each other, the throttle valve opening is kept as the controlled opening at present. Thereafter, control goes to return, waiting for a next activation timing.

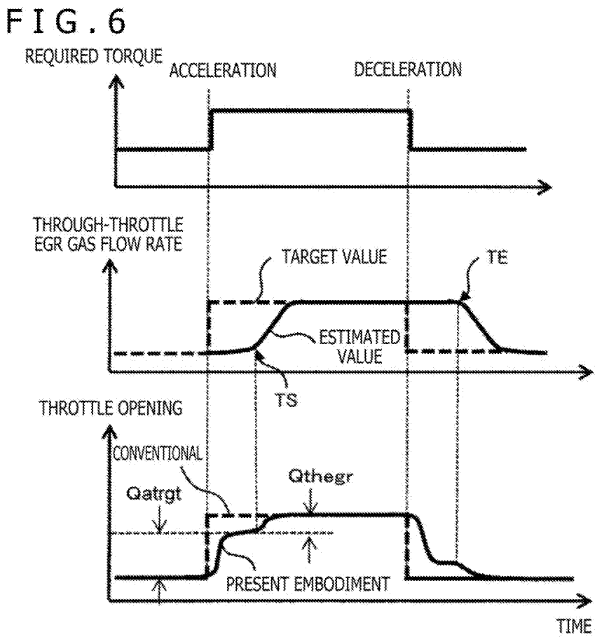

FIG. 6 illustrates chronological changes of a target torque, a throttle-through EGR gas flow rate, and a throttle valve opening upon acceleration and deceleration according to the second embodiment.

Inasmuch as the EGR gas has a delay time upon acceleration, the throttle valve 25 is controlled for a target throttle valve opening corresponding to the target fresh intake air flow rate Qatrgt until the through-throttle EGR gas flow rate Qthegr increases. Thereafter, as the EGR gas reaches the throttle valve 25 at time TS, the throttle valve 25 is controlled for a throttle valve opening corresponding to the target throttle intake gas flow rate Qgth that is the sum of the through-throttle EGR gas flow rate Qthegr and the target fresh intake air flow rate Qatrgt. At this time, according to the control sequence described above, the through-throttle EGR gas flow rate Qthegr and the target EGR gas flow rate Qegr are compared with each other, and the throttle valve 25 is controlled to correct the throttle valve opening.

In the same manner upon deceleration, until time TE when the through-throttle EGR gas flow rate Qthegr starts decreasing, the throttle valve 25 is controlled for a throttle valve opening corresponding to the target throttle intake gas flow rate Qgth that is the sum of the through-throttle EGR gas flow rate Qthegr and the target fresh intake air flow rate Qatrgt. At this time, too, according to the control sequence described above, the through-throttle EGR gas flow rate Qthegr and the target EGR gas flow rate Qegr are compared with each other, and the throttle valve 25 is controlled to correct the throttle valve opening.

As described above, the present embodiment operates in the same manner and offers the same advantages as with the first embodiment. In addition, since the opening of the throttle valve is corrected by comparing through-throttle EGR gas flow rate Qthegr and the target EGR gas flow rate Qegr with each other, the throttle opening can be controlled further accurately for increasing the accuracy with which to control the produced torque.

### Third Embodiment

Next, a third embodiment of the present invention will be described below. The present embodiment is different from the first embodiment in that the opening of the throttle valve is controlled depending on the environment, i.e., a temperature and a pressure, upstream of the throttle valve 25 and environment, i.e., a temperature and a pressure, downstream of the throttle valve 25.

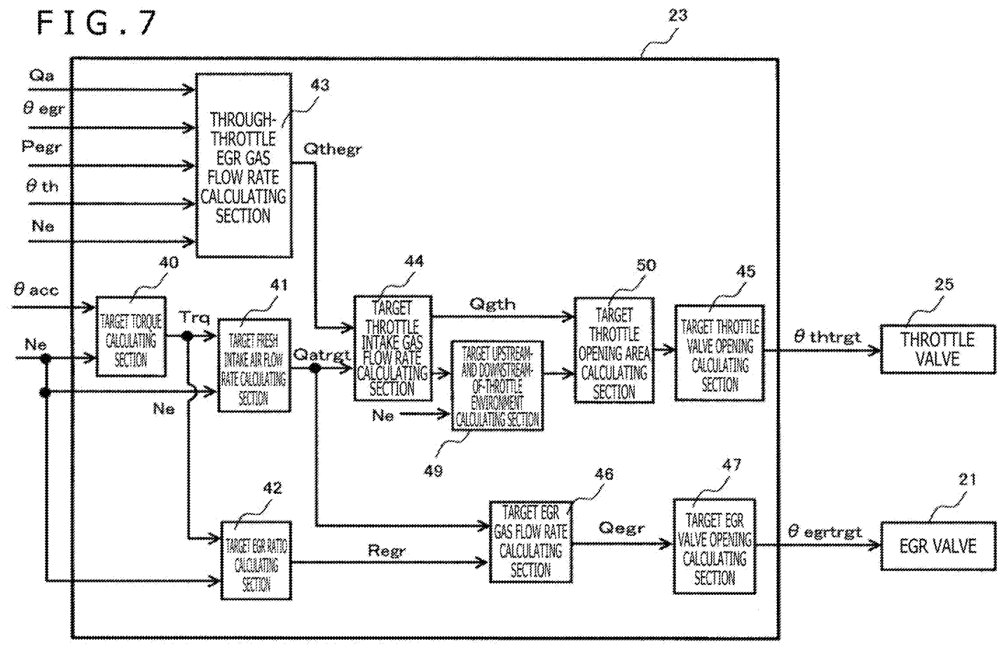

FIG. 7 illustrates a control block of a controller device 23 according to the third embodiment. The controller device 23 includes a target upstream- and downstream-of-throttle environment calculating section 49 and a target throttle opening area calculating section 50 that are newly added between the target throttle intake gas flow rate calculating section 44 and the target throttle valve opening calculating section 45 illustrated in FIG. 2 according to the first embodiment.

The target upstream- and downstream-of-throttle environment calculating section 49 calculates at least a target temperature TTᵤₚ and a target pressure TPᵤₚ that are to be attained upstream of the throttle valve 25 and a target pressure TP_{dn} that is to be attained downstream of the throttle valve 25, based on the target throttle intake gas flow rate Qgth calculated by the target throttle intake gas flow rate calculating section 44 and the rotational speed Ne. The target temperature TTᵤₚ, the target pressure TPᵤₚ, and the target pressure TP_{dn} described above may be determined using other methods than the target throttle intake gas flow rate Qgth.

The target throttle opening area calculating section 50 calculates a target throttle opening area Aᵥ according to the following equation (3) based on the target throttle intake gas flow rate Qgth from the target throttle intake gas flow rate calculating section 44 and the target temperature TTᵤₚ, the target pressure TPᵤₚ, and the target pressure TP_{dn} determined by the target upstream- and downstream-of-throttle environment calculating section 49. In the equation (3), μᵥ represents a flow rate coefficient.

$$\begin{matrix}[ Equation 3 ] & \\ {A}_{v} = \frac{{Q}_{gth}}{{μ}_{v} \times {TP}_{up} \sqrt{\frac{2}{{TP}_{up} \times {TT}_{up}} \times Ψ ( {TP}_{up} , {TP}_{dn} )}} & ( 3 )\end{matrix}$$

The determined target throttle opening area Aᵥ is sent to the target throttle valve opening calculating section 45. The target throttle valve opening calculating section 45 converts the target throttle opening area Aᵥ into a target throttle valve opening θthtrgt. The target throttle valve opening θthtrgt is sent to the electric motor that actuates the throttle valve 25 to control the throttle valve opening. In this case, too, the target throttle valve opening θthtrgt may be determined according to a formula or may be determined from a map based on the target throttle opening area Aᵥ. According to the present embodiment, a map retrieval process is employed for higher calculation speeds.

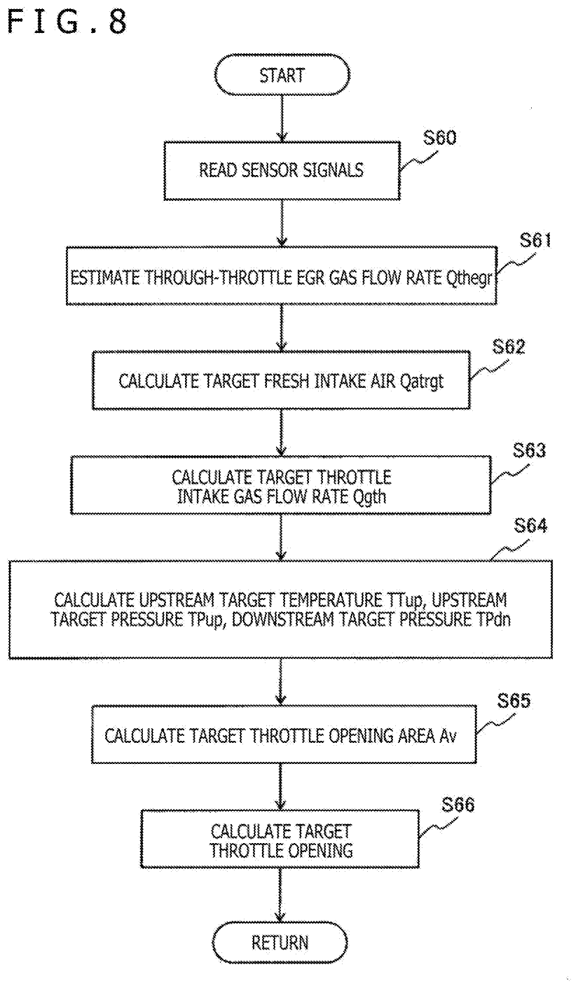

Next, a control sequence of the throttle valve controller device according to the third embodiment described above will briefly be described below with reference to FIG. 8.

<<Step S60>> In step S60, the various sensors read the air flow rate Qa, the EGR valve opening θegr, the differential pressure Pegr across the EGR valve, the throttle valve opening θth, the rotational speed Ne, and the like required by the physical model that estimates a through-throttle EGR gas flow rate. When the inputs required by the physical model have been read, control goes to step S61.

<<Step S61>> In step S61, the flow rate of the EGR gas as the EGR gas flows from the EGR valve 21 until the EGR gas passes through the throttle valve 25 is calculated from the physical model based on the read inputs in view of the operation delay time, i.e., the dead dime, of the EGR valve 21 and the flow delay times due to the passage lengths of the EGR passage 16 and the intake passage 19, and the through-throttle EGR gas flow rate Qthegr that is to pass finally through the throttle valve 25 is estimated. When the through-throttle EGR gas flow rate Qthegr has been determined, control goes to step S62.

<<Step S62>> In step S62, a target fresh intake air flow rate Qatrgt is calculated from the target torque Trq calculated by the target torque calculating section 40 and the rotational speed Ne. When the target fresh intake air flow rate Qatrgt has been determined, control goes to step S63.

<<Step S63>> In step S63, a target throttle intake gas flow rate Qgth is calculated by adding the through-throttle EGR gas flow rate Qthegr determined in step S61 and the target fresh intake air flow rate Qatrgt determined in step S62. When the target throttle intake gas flow rate Qgth has been determined, control goes to step S64.

<<Step S64>> In step S64, a target temperature TTᵤₚ and a target pressure TPᵤₚ upstream of the throttle valve 25 and a target pressure TP_{dn} downstream of the throttle valve 25 are calculated from the target throttle intake gas flow rate Qgth determined in step S63. When the target temperature TTᵤₚ and the target pressure TPᵤₚ upstream of the throttle valve 25 and the target pressure TP_{dn} downstream of the throttle valve 25 have been determined, control goes to step S65.

<<Step S65>> In step S65, a target throttle opening area Aᵥ is calculated according to the above equation (3) from the target temperature TTᵤₚ and the target pressure TPᵤₚ upstream of the throttle valve 25 and the target pressure TP_{dn} downstream of the throttle valve 25. When the target throttle opening area Aᵥ has been determined, control goes to step S66.

<<Step S66>> In step S66, the determined target throttle opening area Aᵥ is converted into a target throttle valve opening θthtrgt. In this case, a target throttle valve opening θthtrgt is determined from the target throttle opening area Aᵥ by way of map retrieval. After the target throttle valve opening θthtrgt is determined, control goes to return, waiting for a next activation timing.

According to the present embodiment, as described above, since the target temperature TTᵤₚ and the target pressure TPᵤₚ upstream of the throttle valve 25 and the target pressure TP_{dn} downstream of the throttle valve 25 vary depending on the through-throttle EGR gas flow rate Qthegr through the intake throttle valve 25, the number of matching steps can be reduced while increasing the accuracy with which to control the produced torque.

The internal combustion engine used in the above embodiments is a spark-ignition internal combustion engine with ignition plugs. However, the present invention is also applicable to a compression-ignition internal combustion engine, e.g., a diesel engine or a premixture compression-ignition internal combustion engine.

According to the present invention, as described above, the throttle valve controller device includes the target fresh intake air flow rate calculating section that calculates a target fresh intake air flow rate passing through the throttle valve, the EGR gas flow rate calculating section that calculates an estimated EGR gas flow rate passing through the throttle valve, the target intake gas flow rate calculating section that calculates a target intake gas flow rate passing through the throttle valve on the basis of the target fresh intake air flow rate and the estimated EGR gas flow rate, and the target throttle valve opening calculating section that calculates a target throttle valve opening for the throttle valve from the target intake gas flow rate.

With the above arrangement, since the target throttle opening is set based on the target fresh intake air flow rate and the through-throttle EGR gas flow rate passing through the throttle valve, a target torque can be produced accurately.

The present invention is not limited to the embodiments described above, but may cover various changes and modifications. For example, the above embodiments have been described in detail for a better understanding of the present invention, and the invention should not necessarily be limited to those including all the described components. Some of the components of an embodiment may be replaced with components of another embodiment, and components of an embodiment may be combined with components of another embodiment added thereto. Furthermore, some of the components of each embodiment may be combined with other components added thereto, deleted, or replaced with other components.

### DESCRIPTION OF REFERENCE CHARACTERS

10: Internal combustion engine
11: Exhaust passage
12: Turbocharger
13: Pre-catalytic converter
14: Main catalytic converter
15: Particle removal filter
16: EGR pipe
17: Gas cooler
18: Combustion cylinder
19: Intake passage
20: Air cleaner
21: EGR valve
22: Differential pressure sensor
23: Controller device
24: Air flow rate sensor
25: Throttle valve
26: Intake pipe
27: Variable-phase valve timing mechanism
28: Accelerator pedal
40: Target torque calculating section
41: Target fresh intake air flow rate calculating section
42: Target EGR ratio calculating section
43: Through-throttle EGR gas flow rate calculating section
44: Target throttle intake gas flow rate calculating section
45: Target throttle valve opening calculating section
46: Target EGR gas flow rate calculating section
47: Target EGR valve opening calculating section

1. A throttle valve controller device for use in an internal combustion engine including a throttle valve disposed in an intake passage connected to a combustion cylinder and an EGR valve disposed in an EGR passage that interconnects the intake passage upstream of the throttle valve and an exhaust passage, for allowing an exhaust gas, hereinafter referred to as “EGR gas,” to flow into the intake passage, the throttle valve controller device including control means controlling the throttle valve, the control means comprising at least:
a target fresh intake air flow rate calculating section that calculates a target fresh intake air flow rate passing through the throttle valve;
a through-throttle EGR gas flow rate calculating section that calculates a through-throttle EGR gas flow rate passing through the throttle valve;
a target throttle intake gas flow rate calculating section that calculates a target throttle intake gas flow rate passing through the throttle valve on a basis of the target fresh intake air flow rate and the through-throttle EGR gas flow rate; and
a target throttle valve opening calculating section that calculates a target throttle valve opening for the throttle valve from the target throttle intake gas flow rate.

2. The throttle valve controller device for use in an internal combustion engine, according to claim 1, wherein
the through-throttle EGR gas flow rate calculating section calculates the through-throttle EGR gas flow rate by reflecting a delay time for the EGR gas as the EGR gas passes through the EGR valve until the EGR gas reaches the throttle valve; and
the target throttle intake gas flow rate calculating section determines the target throttle intake gas flow rate by adding the target fresh intake air flow rate and the through-throttle EGR gas flow rate.

3. The throttle valve controller device for use in an internal combustion engine, according to claim 2, wherein
the target throttle intake gas flow rate calculating section determines the target fresh intake air flow rate calculated by the target fresh intake air flow rate calculating section as the target throttle intake gas flow rate until the through-throttle EGR gas flow rate calculated by the through-throttle EGR gas flow rate calculating section starts to increase after a request for increasing a target torque is made, and
the target throttle valve opening calculating section calculates the target throttle valve opening from the target fresh intake air flow rate.

4. The throttle valve controller device for use in an internal combustion engine, according to claim 2, wherein
the target throttle intake gas flow rate calculating section determines the target throttle intake gas flow rate by adding the target fresh intake air flow rate calculated by the target fresh intake air flow rate calculating section and the through-throttle EGR gas flow rate calculated by the through-throttle EGR gas flow rate calculating section to each other until the through-throttle EGR gas flow rate calculated by the through-throttle EGR gas flow rate calculating section starts to decrease after a request for reducing a target torque is made, and
the target throttle valve opening calculating section calculates the target throttle valve opening from the target throttle intake gas flow rate.

5. The throttle valve controller device for use in an internal combustion engine, according to claim 1, wherein the control means includes:
a target upstream- and downstream-of-throttle environment calculating section that calculates a target pressure and a target temperature upstream of the throttle valve and a target pressure downstream of the throttle valve on a basis of the through-throttle EGR gas flow rate, and a target throttle opening area calculating section that calculates a target throttle opening area for the throttle valve from the target pressure and the target temperature upstream of the throttle valve and the target pressure downstream of the throttle valve, and
the target throttle valve opening calculating section calculates the target throttle valve opening from the target throttle opening area.

6. The throttle valve controller device for use in an internal combustion engine, according to claim 2, wherein
the target fresh intake air flow rate calculating section calculates the target fresh intake air flow rate based on a target torque from a target torque calculating section that calculates the target torque from a depressed quantity of an accelerator pedal and a rotational speed.

7. The throttle valve controller device for use in an internal combustion engine, according to claim 2, wherein
the through-throttle EGR gas flow rate calculating section includes a physical model, and calculates the through-throttle EGR gas flow rate by inputting at least a detected air flow rate, an opening of the EGR valve, a differential pressure across the EGR valve, an opening of the throttle valve, and a rotational speed to the physical model.

8. The throttle valve controller device for use in an internal combustion engine, according to claim 6, wherein
the target fresh intake air flow rate calculating section calculates the target fresh intake air flow rate from the target torque and the rotational speed by way of map retrieval, and
the target throttle valve opening calculating section calculates the target throttle valve opening from the target throttle intake gas flow rate by way of map retrieval.
